(19) United States
(12) Patent Application Publication
(10) Pub. No.: US 2004/0192433 A1
(43) Pub. Date: Sep. 30, 2004

(54) Gaming machine

(76) Inventor: Richard Johnson, Las Vegas, NV (US)

Correspondence Address: BROWN RAYSMAN MILLSTEIN FELDER & STEINER, LLP, SUITE 711, 1880 CENTURY PARK EAST, LOS ANGELES, CA, 90067, US

(21) Appl. No.: 10/805,101

(22) Filed: Mar. 19, 2004

Related U.S. Application Data
(62) Division of application No. 09/966,776, filed on Sep. 28, 2001, now abandoned.

(51) Int. Cl. G07F 17/34

(52) U.S. Cl. 463/20

(57) ABSTRACT

A top box for a slant top or upright gaming machine is provided. The top box has a door that includes a front display panel. The door is attached to the housing, with a hinge, pivot pins, or the like so that the panel may swing open. The door may be locked to prevent unauthorized persons from accessing the interior of the top box. Casino personnel may open the door in order to service the inside of the top box. In this way, the inside of the top box may be serviced without having to remove the glass panel.

### CROSS-REFERENCE TO RELATED APPLICATION

This is a divisional of U.S. patent application Ser. No. 09/966,776, filed Sep. 28, 2001, now pending.

### FIELD OF THE INVENTION

This invention relates generally to the field of gaming machines and, more particularly, to a gaming machine including a top box cabinet having a door.

### BACKGROUND OF THE INVENTION

Today, many gaming machines in casinos have top boxes. A top box is a cabinet that lies on top of the gaming machine. Top boxes are generally designed without openings or doors because they have to be both water resistant, to prevent liquids from damaging internal components, and secure, so that unauthorized persons are not able to tamper with the interior of the gaming machine.

Moreover, top boxes typically include colorful front panels made of glass that are backlit in order to attract attention to the gaming machine. Consequently, to service the inside of most top boxes, e.g., to fix a light bulb or to access the circuitry located therein, the entire glass panel must be removed from the top box. This process is very cumbersome and the glass panel usually ends up being broken.

Accordingly, those skilled in the art have long recognized a need for a top box, the inside of which may be serviced quickly and efficiently without there being a high probability of breaking the glass located within the top box; that has a simple, cost-effective design; and is suitable for both upright and slant top gaming machines.

### SUMMARY OF THE INVENTION

Briefly, and in general terms, the present invention provides a top box, the inside of which may be serviced quickly and efficiently without there being a high probability of breaking the glass panel located within the top box; that has a simple, cost-effective design; and is suitable for both upright and slant top gaming machines.

More particularly, by way of example and not necessarily by way of limitation, the present invention provides a top box for an upright or slant top gaming machine, the top box comprising a housing having a substantially hollow interior and a door having a display panel. The display panel is operatively attached to the top box housing preferably by a hinge. However, any means for attaching, including pivot pins, may be used as long as the door may be opened and closed. Furthermore, the top box may be of any shape. A lip or rubber seal at least partially circumscribes the frame so that the lip or rubber seal prevents liquids encountered by the gaming machine from damaging components that are located inside the gaming machine. The cabinet is secured with a lock so that only authorized persons may gain access to its interior.

Hence, the present invention satisfies a long existing need for a top box, the inside of which may be serviced easily without there being a high probability of breaking the glass panel located within the top box; that has a simple, cost-effective design; and is suitable for both upright and slant top gaming machines.

These and other objects and advantages of the invention will become apparent from the following, more detailed description when taken in conjunction with the accompanying drawings of illustrative embodiments.

### BRIEF DESCRIPTION OF THE DRAWINGS

FIG. 1 is an elevational perspective view of an upright gaming device, in accordance with one embodiment of the present invention;

FIG. 2 is an elevational perspective view of an upright gaming device showing a top box with a front panel in an open position, in accordance with the present invention;

FIG. 3 is an elevational perspective view of an upright gaming device, in accordance with a second embodiment of the present invention; and

FIG. 4 is an elevational perspective view of a slant top gaming device, in accordance with a third embodiment of the present invention.

### DETAILED DESCRIPTION OF THE PREFERRED EMBODIMENTS

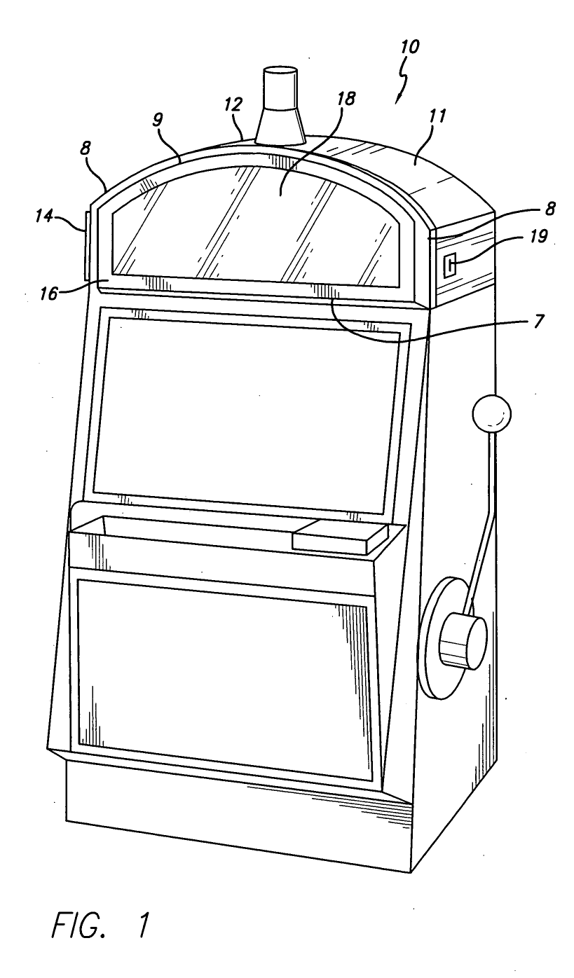

Referring now to the drawings, wherein like reference numerals denote like or corresponding parts throughout the drawing figures and, more particularly, to FIG. 1, there is shown an upright gaming machine 10 having a substantially non-rectangular top box 12. The top box 12 includes a housing 11 and a door 9. The housing has two side portions 8 and a bottom portion 7. The door 9 is comprised of a frame 16 circumscribing the glass panel 18. The frame 16 is attached to the housing 11 by means of a hinge 14 located on the side of the top box 12. Casino personnel may service the inside of the top box 12 by unlocking a lock 19 and swinging open the door 9 via the hinge 14. Thus, there is no need to remove the glass 18 from the top box 12 when seeking access to the interior portion of the top box.

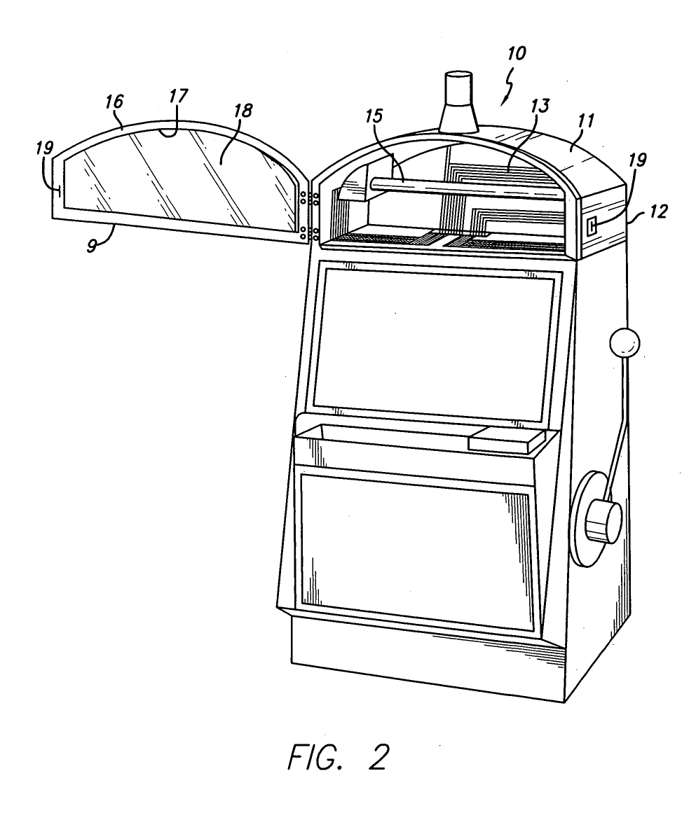

FIG. 2 shows the same embodiment, illustrated in FIG. 1; but with the door 9 in an open position thereby exposing a light bulb 15 and wires 13. Because the door 9 opens outwardly instead of inwardly, the door may be attached to the top box 12 at any point without interfering with the wires 13, circuitry, components, and the like that are housed within the machine 10. A lip 17 fits underneath the housing 11 when the door 9 is closed so that liquid spilled on the machine 10, will not be able to find its way inside the top box 12 to damage the gaming machine.

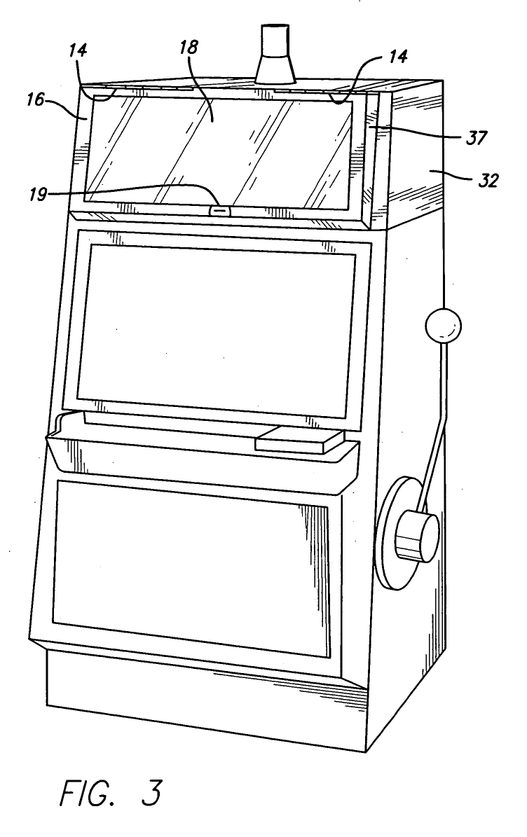

A second embodiment of the invention is shown in FIG. 3. This second embodiment has two hinges 14 that are attached to the top of a rectangular top box 32 and a rubber seal 37 that prevents liquid from entering the top box.

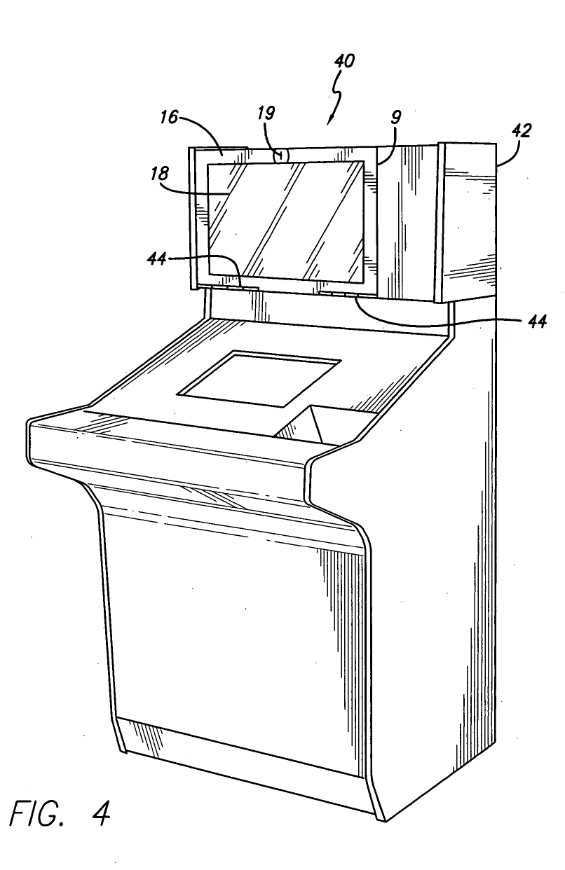

FIG. 4 shows a third embodiment of the invention. A top box 42 sits atop a slant top gaming machine 40. The door 9 is attached to the top box 42 by means of pivot pins 44 located at the bottom of the top box.

It should be appreciated by one skilled in the art that the door on the top box may be attached to the top box at any number of locations using any type of connection means such as hinges, pivot pins, and the like. For example, one or multiple hinges, pivot pins, and the like, or any combination thereof, may be used. It should further be appreciated that the top box may be of any shape.

Hence, the present invention satisfies a long existing need for a top box, the inside of which may be serviced easily without there being a high probability of breaking the glass located within the top box; that has a simple, cost-effective design; and is suitable for both upright and slant top gaming machines.

It will be apparent from the foregoing that, while particular forms of the invention have been illustrated and described, various modifications can be made without departing from the spirit and scope of the invention. Accordingly, it is not intended that the invention be limited, except as by the appended claims.

What is claimed is:

1. A gaming machine having a top box, the gaming machine comprising:
a main gaming machine section; and
a top box having a substantially hollow interior, wherein the top box includes a housing and a substantially non-rectangular door having a display panel, and wherein a hinge operatively attaches the door to the housing.

2. A gaming machine having a top box, the gaming machine comprising:
a main gaming machine section;
a top box having a substantially hollow interior; wherein the top box includes a housing and a substantially non-rectangular door having a display panel; and
means for operably attaching the door to the housing so that the door may be opened and closed.

3. A gaming machine having a top box, the gaming machine comprising:
a main gaming machine section;
a top box having a substantially hollow interior, wherein the top box includes a housing and a substantially non-rectangular door having a display panel; and
means for rotably attaching the door to the housing.

4. The gaming machine as recited in claim 1, further comprising a liquid-resistant seal positioned so that it prevents liquid from passing between the door and the housing.

5. The gaming machine as recited in claim 1, further comprising means for preventing water from passing between the frame and the housing.

6. The gaming machine as recited in claim 1, wherein the door further comprises a lip at least partially circumscribing the door so that the lip prevents liquid from passing between the door and the housing.

7. The gaming machine as recited in claim 1, wherein the top box is secure so that unauthorized personnel cannot access the interior.

8. The gaming machine as recited in claim 7, wherein the top box is secured with a lock.

9. An upright gaming machine having a top box, the gaming machine comprising:
a main gaming machine section; and
a top box having a substantially hollow interior, wherein the top box includes a housing and a substantially non-rectangular door having a display panel, and wherein a hinge operatively attaches the door to the housing.

10. An upright gaming machine having a top box, the gaming machine comprising:
a main gaming machine section; and
a top box having a substantially hollow interior, wherein the top box includes a housing and a substantially non-rectangular door having a display panel; and
means for operably attaching the door to the housing so that the door may be opened and closed.

11. An upright gaming machine having a top box, the gaming machine comprising:
a main gaming machine section; and
a top box having a substantially hollow interior, wherein the top box includes a housing and a substantially non-rectangular door having a display panel; and
means for rotably attaching the door to the housing.

12. The gaming machine as recited in claim 9, further comprising a liquid-resistant seal positioned so that it prevents water from passing between the door and the housing.

13. The gaming machine as recited in claim 9, further comprising means for preventing liquid from passing between the frame and the housing.

14. The gaming machine as recited in claim 9, wherein the door further comprises a lip at least partially circumscribing the door so that the lip prevents liquid from passing between the door and the housing.

15. The gaming machine as recited in claim 9, wherein the top box is secure so that unauthorized personnel cannot access the interior.

16. The gaming machine as recited in claim 15, wherein the top box is secured with a lock.

17. A gaming machine having a top box, the gaming machine comprising:
a main gaming machine section; and
a top box having a substantially hollow interior, wherein the top box includes a housing having a side portion and a substantially non-rectangular door having a display panel, and wherein a hinge operatively attaches the door to the side portion of the housing.

18. A gaming machine having a top box, the gaming machine comprising:
a main gaming machine section;
a top box having a substantially hollow interior, wherein the top box includes a side portion and a substantially non-rectangular door having a display panel; and
means for operably attaching the door to the side portion of the housing so that the door may be opened and closed.

19. A gaming machine having a top box, the gaming machine comprising:
a main gaming machine section;
a top box having a substantially hollow interior; wherein the top box includes a housing having a side portion and a substantially non-rectangular door having a display panel; and
means for rotably attaching the door to the side portion of the housing.

20. The gaming machine as recited in claim 17, further comprising a liquid-resistant seal positioned so that it prevents liquid from passing between the door and the housing.

21. The gaming machine as recited in claim 17, further comprising means for preventing liquid from passing between the frame and the housing.

22. The gaming machine as recited in claim 17, wherein the door further comprises a lip at least partially circumscribing the door so that the lip prevents liquid from passing between the door and the housing.

23. The gaming machine as recited in claim 17, wherein the top box is secure so that unauthorized personnel cannot access the interior.

24. A gaming machine as recited in claim 23, wherein the top box is secured with a lock.

25. A gaming machine having a top box, the gaming machine comprising:
a main gaming machine section;
a top box having a substantially hollow interior, wherein the top box includes housing having a bottom portion, and a substantially non-rectangular door having a display panel; and
a hinge operatively attaching the door to the bottom portion of the housing.

26. A gaming machine having a top box, the gaming machine comprising:
a main gaming machine section;
a top box having a substantially hollow interior, wherein the top box includes housing having a bottom portion, and a substantially non-rectangular door having a display panel; and
means for operably attaching the door to the bottom portion of the housing so that the door may be opened and closed.

27. An upright gaming machine having a top box, the gaming machine comprising:
a main gaming machine section;
a top box having a substantially hollow interior, wherein the top box includes a housing having a side portion, and a substantially non-rectangular door having a display panel, and
means for rotably attaching the door to the side portion of the housing.

28. The gaming machine as recited in claim 25, further comprising a liquid-resistant seal positioned so that it prevents liquid from passing between the door and the housing.

29. The gaming machine as recited in claim 25, further comprising means for preventing liquid from passing between the frame and the housing.

30. A gaming machine as recited in claim 25, wherein the door further comprises a lip at least partially circumscribing the door so that the lip prevents liquid from passing between the door and the housing.

31. The gaming machine as recited in claim 25, wherein the top box is secure so that unauthorized personnel cannot access the interior.

32. The gaming machine as recited in claim 31, wherein the top box is secured with a lock.

33. An upright gaming machine having a top box, the gaming machine comprising:
a main gaming machine section;
a top box having a substantially hollow interior, wherein the top box includes a housing having a side portion, and a substantially non-rectangular door having a display panel; and wherein a hinge operatively attaches the door to the side portion of the housing.

34. An upright gaming machine having a top box, the gaming machine comprising:
a main gaming machine section; and
a top box having a substantially hollow interior, wherein the top box includes a housing having a side portion, and a substantially non-rectangular door having a display panel; and wherein a hinge operatively attaches the door to the side portion of the housing.
